(19) United States
(12) Patent Application Publication
(10) Pub. No.: US 2025/0044979 A1
(43) Pub. Date: Feb. 6, 2025

(54) DATA PROCESSING SYSTEM METHOD AND APPARATUS, COMPUTER DEVICE AND STORAGE MEDIUM

(71) Applicant: Beijing Volcano Engine Technology Co., Ltd., Beijing (CN)

(72) Inventors: Guojun LI, Beijing (CN); Dengcheng ZHU, Los Angeles, CA (US); Wei TANG, Los Angeles, CA (US); Fei LIU, Los Angeles, CA (US); Peng LIU, Beijing (CN)

(21) Appl. No.: 18/784,916

(22) Filed: Jul. 26, 2024

(30) Foreign Application Priority Data
Aug. 1, 2023 (CN) 202310961799.X

(51) Int. Cl. G06F 3/06

(52) U.S. Cl. CPC G06F 3/0655; G06F 3/0604; G06F 3/0673

(57) ABSTRACT

The present disclosure provides a data processing system and method, a computer device and a storage medium. The method includes: reading first data from a first memory space of a target memory space and splitting the first data to obtain multiple segments of second data; determining check information corresponding to each segment of the second data, and storing the check information of each segment of the second data as third data in a second memory space of the target memory space; generating a data assembly instruction based on a data assembly order for the second data and the third data; and sending the data assembly instruction to a storage acceleration module, enabling the storage acceleration module to write the fourth data into the hard disk based on read data and the target data structure.

### CROSS-REFERENCE TO RELATED APPLICATIONS

This application claims the priority of Chinese Patent Application No. 202310961799.X filed on Aug. 1, 2023, which is incorporated herein by reference in its entirety.

### TECHNICAL FIELD

Embodiments of the present disclosure relates to a data processing system and method, a computer device and a storage medium.

### BACKGROUND

In traditional distributed storage systems, data transfer between computer nodes is often required. After receiving data through the network card, computers need to go through multiple copying processes to store the data on the hard drive, leading to increased data transfer latency and system overhead. Data copying consumes memory bandwidth and CPU resources, and additional memory may be required to store temporary data. The extra resource consumption and memory requirements can restrict the performance of the distributed system.

Additionally, in distributed systems, to ensure the reliability of data, it is common practice to store check information corresponding to the data. The data stored on the lower disk are different from the original data received, requiring the generation of data with check information for storage. This will further increase the number of copying processes and lead to a write amplification effect, thereby further increasing resource consumption.

### SUMMARY

Embodiments of the present disclosure at least provides a data processing system and method, computer device and storage medium.

An embodiment of the present disclosure provides a data processing system, including a network card module, a data management module, a storage acceleration module and a hard disk; wherein the network card module, the data management module and the storage acceleration module have read-write access permission for a target memory space;
the network card module is configured to receive first data transmitted by a network and store the first data in a first memory space of the target memory space;
the data management module is configured to read the first data from the first memory space and split the first data to obtain multiple segments of second data; determine check information corresponding to each segment of the second data, and store the check information of each segment of the second data as third data in a second memory space of the target memory space; and generate a data assembly instruction based on a data assembly order for the second data and the third data; wherein the data assembly instruction is used for generating fourth data with a target data structure, the target data structure indicates data source of each segment of subdata in the fourth data, and the subdata includes the second data and the third data; and
the storage acceleration module is configured to control the hard disk to read the second data and the third data from the target memory space, and write the fourth data into the hard disk based on read data and the target data structure.

In the embodiment of the present disclosure, a network card module, a data management module and a storage acceleration module all have read-write access permission for a first memory space, so that the first data received by the network card module are shared among the modules without data transmission and copying, thus reducing resource occupation. In addition, by storing check information in a second memory space, using the storage acceleration module to control a hard disk to directly obtain data from the first memory space and the second memory space and directly write the data into the hard disk, and allowing the hard disk to assemble the data, zero-copy data transmission is achieved, and data assembly in the data management module is avoided, thus further reducing resource consumption.

Further, through the realization of memory universality and zero-copy data transmission, the delay of data transmission is effectively reduced, the bandwidth utilization rate of data transmission is improved, the memory occupation demand of the system is reduced, performance issues caused by memory bandwidth bottleneck and load occupancy are reduced, and the performance, efficiency, response speed and resource utilization rate of the system are improved.

In an optional implementation, the network card module, the data management module and the storage acceleration module run in the same thread.

In the embodiment of the present disclosure, the network card module, the data management module and the storage acceleration module run in the same thread. In this way, the network card module, the data management module and the storage acceleration module may access the same target memory space, so the data can be directly transmitted in the memory without the need for additional memory copying and data replication, facilitating efficient memory universality and zero-copy data transmission. Additionally, it eliminates the need for complex memory sharing settings, making it easy to implement.

In an optional implementation, wherein the storage acceleration module, when controlling the hard disk to read the second data and the third data from the target memory space, is configured to:
acquire a memory mapping table of the network card module, wherein the memory mapping table contains a mapping relationship between a virtual memory address and a physical memory address of the network card module;
control the hard disk to determine physical memory addresses of the second data and the third data based on the memory mapping table; and
control the hard disk to read the second data and the third data based on the physical memory addresses.

In this way, through the memory mapping table which records the mapping relationship between the virtual memory address and the physical memory address of the network card module, the hard disk may be controlled by the storage acceleration module to determine the physical memory addresses of the second data and the third data according to the memory mapping table, so that the hard disk is controlled to read the second data and the third data based on the physical memory addresses, and the direct access of the hard disk to the data transmitted by the network card module is realized. Therefore, the data may be directly transmitted between the network card module and the hard disk to avoid additional memory copying and data replication, thus contributing to the realization of efficient memory universality and zero-copy data transmission.

In an optional implementation, wherein the storage acceleration module, when controlling the hard disk to read the second data and the third data from the target memory space, and write the fourth data into the hard disk based on the read data and the target data structure, is configured to:
use a storage performance development kit (SPDK) to control the hard disk to read the second data and the third data from the target memory space, and write the fourth data into the hard disk based on the read data and the target data structure.

In this way, the storage acceleration module may control the data reading and data writing of the hard disk by using the SPDK, which runs in the user mode, thus eliminating the data copying process from a kernel buffer designed in a traditional IO path to a user buffer, so as to realize the data transfer from the user-mode memory to the hard disk without additional memory copying.

In an optional implementation, wherein the data management module determines the data assembly order by the following steps:
determining position information of the multiple segments of second data in the first data; and
determining the data assembly order based on the position information and an association relationship between the second data and the third data.

In the embodiment of the present disclosure, the data assembly order for the second data and the third data may be determined according to the position of each segment of the second data in the first data and the association relationship between the second data and the third data, which facilitates the combination of multiple segments of discontinuous data according to the data assembly order, so as to write the assembled fourth data into the hard disk and help eliminate data copies introduced by data reorganization in the related art.

In an optional implementation, the data management module is configured to:
split the first data based on a preset data segmentation size to obtain multiple segments of second data, and perform a padding operation on target second data at a tail end of the first data to obtain padded data;
determine cyclic redundancy check information corresponding to other second data than the target second data and cyclic redundancy check information of the padded data;
for any of the other second data, take the cyclic redundancy check information of the other second data as check information corresponding to the other second data;
take the cyclic redundancy check information of the padded data as check information of the target second data; and
store padding data added to the target second data in the padding operation into the second memory space as the third data.

In the embodiment of the present disclosure, by performing padding operation on the target second data at the tail end of the first data and storing the padding data added to the target second data as the third data in the second memory space, it is ensured that the length of the fourth data is in integer units, and for the other second data and the padded data, data reliability is guaranteed by determining the corresponding check information based on the corresponding cyclic redundancy check information.

The embodiment of the present disclosure also provides a data processing method, which is applied to a data management module, and the method includes:
reading first data from a first memory space of a target memory space and splitting the first data to obtain multiple segments of second data;
determining check information corresponding to each segment of the second data, and storing the check information of each segment of the second data as third data in a second memory space of the target memory space;
generating a data assembly instruction based on a data assembly order for the second data and the third data, wherein the data assembly instruction is used for generating fourth data with a target data structure, the target data structure indicates data source of each segment of subdata in the fourth data, and the subdata includes the second data and the third data; and
sending the data assembly instruction to a storage acceleration module, enabling the storage acceleration module to control a hard disk to read the second data and the third data from the target memory space, and write the fourth data into the hard disk based on the read data and the target data structure; wherein the data management module and the storage acceleration module have read-write access permission for the target memory space.

The data processing method provided by the embodiment of the present disclosure involves splitting the first data stored in the first memory space to obtain the multiple segments of second data, determining the check information of each segment of second data and storing the same as the third data in the second memory space, determining the data assembly instruction for generating the fourth data with the target data structure, and sending the data assembly instruction to the storage acceleration module, so that the storage acceleration module controls the hard disk to read the second data and the third data from the target memory space, enabling the writing of the fourth data into the hard disk in compliance with the target data structure, including the second data and the third data. In this way, through the data transmission from the data management module to the storage acceleration module and the cooperation between the modules, the data are split by the data management module after being received from the network card module, and then written into the hard disk under the control of the storage acceleration module, thus avoiding additional memory copying and data replication, eliminating the data copying introduced by data reorganization in the related art, and realizing efficient memory universality and zero-copy data transmission.

Further, through the realization of memory universality and zero-copy data transmission, the delay of data transmission is effectively reduced, the bandwidth utilization rate of data transmission is improved, the memory occupation demand of the system is reduced, performance issues caused by memory bandwidth bottleneck and load occupancy are reduced, and the performance, efficiency, response speed and resource utilization rate of the system are improved.

An embodiment of the present disclosure also provides a data processing device, which includes a data splitting module, an information determination module, a data assembly module and an instruction sending module,
a data splitting module is configured to read first data from a first memory space of a target memory space and split the first data to obtain multiple segments of second data;
an information determination module is configured to determine check information corresponding to each segment of the second data, and store the check information of each segment of the second data as third data in a second memory space of the target memory space;
a data assembly module is configured to generate a data assembly instruction based on a data assembly order for the second data and the third data, wherein the data assembly instruction is used for generating fourth data with a target data structure, the target data structure indicates data sources of each segment of subdata in the fourth data, and the subdata includes the second data and the third data; and
an instruction sending module is configured to send the data assembly instruction to a storage acceleration module, enabling the storage acceleration module to control a hard disk to read the second data and the third data from the target memory space, and write the fourth data into the hard disk based on the read data and the target data structure; wherein the data management module and the storage acceleration module have read-write access permission for the target memory space.

An optional implementation of the present disclosure also provide a computer device, including at least one processor and at least one memory, wherein the at least one memory stores machine-readable instructions executable by the at least one processor, the at least one processor is used for executing the machine-readable instructions stored in the at least one memory, and when the machine-readable instructions are executed by the at least one processor, the at least one processor executes the steps of the data processing method described above.

An optional implementation of the present disclosure also provides a computer-readable storage medium, wherein a computer program is stored on the computer-readable storage medium, and when the computer program is run on a computer device, the computer device executes the steps of the data processing method described above.

For the effect description of the above data processing apparatus, computer device and computer-readable storage medium, please refer to the description of the above data processing method, which will not be repeated here.

It should be understood that the above general description and the following detailed description are exemplary and explanatory only, and are not restrictive of the technical scheme of the present disclosure.

In order to make the above objects, features and advantages of the present disclosure more evident and comprehensible, the following detailed description is provided, illustrating exemplary embodiments and accompanied by the attached drawings.

### BRIEF DESCRIPTION OF THE DRAWINGS

In order to explain the technical schemes of embodiments of the present disclosure more clearly, the accompanying drawings to be used in the illustration of the embodiments are briefly described below. The accompanying drawings, which are incorporated in and constitute a part of this specification, illustrate embodiments consistent with the present disclosure and together with the specification, serve to explain the technical schemes of the present disclosure. It should be understood that the following accompanying drawings only show some embodiments of the present disclosure and therefore should not be construed as a limitation on the scope of the present disclosure. For those of ordinary skill in the art, other relevant drawings can be derived on the basis of these drawings without any inventive effort.

FIG. 1 is a principle block diagram of a data processing system according to some embodiments of the present disclosure;

FIG. 2 is a schematic diagram of a data processing process according to some embodiments of the present disclosure;

FIG. 3 is a schematic diagram of another data processing process according to some embodiments of the present disclosure;

FIG. 4 is a flowchart of a data processing method according to some embodiments of the present disclosure;

FIG. 5 is a schematic diagram of a data processing apparatus according to some embodiments of the present disclosure; and

FIG. 6 is a schematic diagram of a computer device according to some embodiments of the present disclosure.

### DETAILED DESCRIPTION

In order to make the purpose, technical scheme and advantages of the embodiments of the present disclosure more clear, the technical scheme in the embodiments of the present disclosure will be described clearly and completely with reference to the attached drawings. Obviously, the described embodiments are only part of the embodiments of the present disclosure, not all of them. The components in the embodiments of the present disclosure generally described and illustrated herein may be arranged and designed in various different configurations. Therefore, the following detailed description of the embodiments of the present disclosure is not intended to limit the scope of the claimed disclosure, but merely represents selected embodiments of the present disclosure. Based on the embodiments of the present disclosure, all other embodiments obtained by those skilled in the art without creative work belong to the scope of protection of the present disclosure.

It should be noted that similar reference numerals and letters indicate similar items in the following figures, so once an item is defined in one figure, it will not be further defined and explained in subsequent figures.

The term “and/or” herein only describes an associative relationship, which means that there can be three kinds of relationships, for example, A and/or B can mean A alone; A and B; and B alone. In addition, the term “at least one” herein means any one of multiple options or any combination of at least two options among multiple options. For example, having at least one of A, B, or C can indicate selecting any one or more elements from the set consisting of A, B, and C.

It is found through research that a storage performance development kit (SPDK) may be used to eliminate memory copies transmitted from a user-mode memory to a hard disk. However, in this way, although no memory copy is needed from an SPDK buffer to the hard disk, the transfer of data from a network card buffer (user mode) to a memory of the SPDK will also involve a memory copying process. Additionally, in distributed systems, to ensure the reliability of data, it is common practice to store check information corresponding to the data, resulting in the data stored on the lower disk being different from the original data received. Therefore, the buffer data received by the network card cannot be directly transmitted to the hard disk, and the generation of data with check information is required for storage. This will further increase the number of copying processes and lead to a write amplification effect, thereby further increasing resource consumption and increasing the demand on memory bandwidth and CPU. As a result, additional memory is required, and system efficiency and performance are impacted.

Based on the above research, the present disclosure provides a data processing system, method and apparatus, a computer device and a storage medium. A network card module, a data management module and a storage acceleration module all have read-write access permission for a first memory space, so that first data received by the network card module are shared among the modules without data transmission and copying, thus reducing resource occupation. In addition, by storing check information in a second memory space, using the storage acceleration module to control a hard disk to directly obtain data from the first memory space and the second memory space and directly write the data into the hard disk, and allowing the hard disk to assemble the data, zero-copy data transmission is achieved, and data assembly in the data management module is avoided, thus further reducing resource consumption.

The defects identified in the above schemes are the results of the inventors' practice and careful study. Therefore, the discovery process of the above problems and the solutions proposed in this disclosure should all be considered as the contributions made by the inventors in this disclosure process.

Hereinafter, embodiments of the present disclosure will be described with reference to the accompanying drawings.

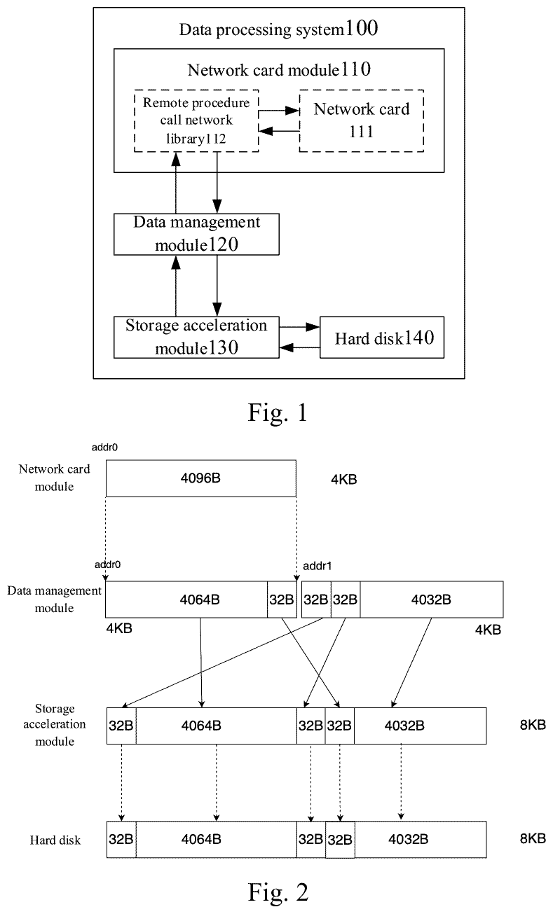

Please refer to FIG. 1, which shows a data processing system provided by an embodiment of the present disclosure. As shown in FIG. 1, a data processing system 100 provided by the embodiment of the present disclosure includes a network card module 110, a data management module 120, a storage acceleration module 130 and a hard disk 140.

Optionally, the hard disk 140 may be a Non Volatile Memory express (NVMe), and a nonvolatile memory of an NVMe disk can provide better performance and reduce the delay.

Here, the network card module 110, the data management module 120, and the storage acceleration module 130 have read-write access permission for a target memory space. The target memory space may include a plurality of memory spaces.

In an alternative implementation mode, the network card module 110 includes a network card 111 and a remote procedure call (RPC) network library 112, and the RPC network library 112 manages and controls the network card 111.

The network card module 110 is configured to receive first data transmitted by a network and store the first data in a first memory space of the target memory space.

Accordingly, in response to the first data being transmitted to the network card 111, the RPC network library 112 controls the network card 111 to receive the first data, and store the first data in the first memory space of the target memory space, so as to transmit the first data to the data management module 120.

The first data may be sent to the network card module 110 by other modules through a network.

It can be understood that since both the network card module 110 and the data management module 120 have read-write access permission for the target memory space, the data management module 120 may receive data from the network card module 110 by reading data from the first memory space.

In order to enable the network card module 110, the data management module 120 and the storage acceleration module 130 to have read-write access permission for the target memory space, in some embodiments, the network card module 110, the data management module 120 and the storage acceleration module 130 share part of the memory, that is, the target memory space is the memory shared by the network card module 110, the data management module 120 and the storage acceleration module 130.

In some other embodiments, in order to reduce the memory management cost, the network card module 110, the data management module 120 and the storage acceleration module 130 may run in the same thread.

In this way, the network card module, the data management module and the storage acceleration module may access the same target memory space, so the data can be directly transmitted in the memory without the need for additional memory copying and data replication, facilitating efficient memory universality and zero-copy data transmission. Additionally, it eliminates the need for complex memory sharing settings, making it easy to implement.

In order to clearly show the data processing process, FIG. 2 shows a schematic diagram of a data processing process according to an embodiment of the present disclosure. As shown in FIG. 2, the network card module is configured to receive the first data. In this example, the first data are 4096 bytes (4 KB of storage space is required), and the network card module is configured to store the first data in the first memory space with the starting address addr0 and occupying 4 KB of memory. Here, the starting address is a virtual memory address.

The data management module 120 is configured to receive the data from the network card module 110, and to process, organize and reorganize the data, specifically to combine the received data with corresponding check information and reorganize the layout of the data.

Specifically, the data management module 120 is configured to read the first data from the first memory space and split the first data to obtain multiple segments of second data; determine check information corresponding to each segment of the second data, and store the check information of each segment of the second data as third data in a second memory space of the target memory space; and generate a data assembly instruction based on a data assembly order for the second data and the third data; wherein the data assembly instruction is used for generating fourth data with a target data structure, the target data structure indicates data source of each segment of subdata in the fourth data, and the subdata includes the second data and the third data.

Optionally, the data management module 120 may receive the starting address and a stored data length of the first memory space sent by the network card module 110, and read the first data from the first memory space based on the starting address and the stored data length.

The data management module 120 may split the first data according to preset data splitting requirements, and the data splitting requirements indicate the number of second data obtained after splitting, a length of each segment of second data and a splitting order.

After the multiple segments of second data are obtained after splitting by the data management module 120, the data management module 120 applies for a new second memory space in the target memory space, and the second memory space is used for storing the third data.

Here, the second memory space and the first memory space may not be continuous memory spaces.

For example, as shown in FIG. 2, the starting address of the first memory space is addr0, and the ending address is 4 KB after addr0, while the starting address of the second memory space is addr1, which is not necessarily the same as the ending address of the first memory space.

After storing the third data in the second memory space, the data management module 120 determines a data assembly order for the second data and the third data, then generate a data assembly instruction based on the data assembly order, and then send the data assembly instruction to the storage acceleration module 130 for the storage acceleration module 130 to control the hard disk 140 to read and write data based on the data assembly instruction.

Optionally, the data assembly instruction may be organized by a scatter gather list (SGL), so as to combine the data in multiple discontinuous memory spaces according to the data assembly order.

For the determination of the data assembly order, in some embodiments, the data management module 120 is configured to determine position information of the multiple segments of second data in the first data; and determine the data assembly order based on the position information and an association relationship between the second data and the third data.

In the above steps, the data management module 120 first determines the position information of each segment of the second data, and then determines the data assembly order based on the association relationship between each of the second data and each of the third data. Here, the position information is used for indicating the position and arrangement order of the second data in the first data, and the association relationship is used for indicating the corresponding second data and third data.

Optionally, the data assembly order may be to keep the arrangement order of the second data and add the third data corresponding to the second data between two adjacent second data, thereby combining the second data with the associated third data.

In this way, the data assembly order for the second data and the third data may be determined according to the position of each segment of the second data in the first data and the association relationship between the second data and the third data, which facilitates the combination of multiple segments of discontinuous data according to the data assembly order, so as to write the assembled fourth data into the hard disk and help eliminate data copies introduced by data reorganization in the related art.

In practical use, the length of most data to be written in the memory space is in integer units. Therefore, after determining the check information of each segment of the second data, it may be determined whether the total length of all the check information meets a preset integer unit length. If so, the data management module 120 may store the check information of each segment of the second data as third data in the second memory space. If not, the data management module 120 may supplement the second data with padding data and store the padding data and the check information in the second memory space together, thus ensuring that the length of data stored in the second memory space is in integer units.

Accordingly, in some embodiments, the data management module 120 is configured to: split the first data based on a preset data segmentation size to obtain multiple segments of second data, and perform a padding operation on target second data at a tail end of the first data to obtain padded data; determine cyclic redundancy check information corresponding to other second data than the target second data and cyclic redundancy check information of the padded data; for any of the other second data, take the cyclic redundancy check information of the other second data as check information corresponding to the other second data; take the cyclic redundancy check information of the padded data as check information of the target second data; and store padding data added to the target second data in the padding operation into the second memory space as the third data.

In this way, by performing padding operation on the target second data at the tail end of the first data and storing the padding data added to the target second data as the third data in the second memory space, it is ensured that the length of the fourth data is in integer units, and for the other second data and the padded data, data reliability is guaranteed by determining the corresponding check information based on the corresponding cyclic redundancy check information.

For example, the splitting of the first data and the generation of the third data may be based on the number of bytes required for the check information and the unit length mentioned above. For example, in response to the check information including 32 bytes and the requirement for data alignment being to align based on 4 KB, as shown in FIG. 2, after the network card module stores the first data in the first memory space with the starting address addr0, the data management module reads the first data of 4096 B from the first memory space, and newly applies for the second memory space with the starting address addr1 and 4 KB of memory from the target memory space; based on the above segmentation conditions, the first data are split to obtain two segments of second data, with sizes of 4064 B and 32 B respectively, padding operation is performed on the target second data of 32 B located at the tail end of the first data, and data of 4032 B are added to the target second data as the padding data to obtain padded data; then the cyclic redundancy check information of 32 B corresponding to other second data of 4064 B than the target second data and the cyclic redundancy check information of 32 B of the padded data are determined, and for the other second data of 4064 B, the cyclic redundancy check information of 32 B of the other second data of 4064 B is taken as the check information corresponding to the other second data of 4064 B; and the cyclic redundancy check information of 32 B of the padded data is taken as the check information of the target second data, the check information of each segment of the second data is stored in the second memory space as the third data, and at the same time, the padding data of 4032 B added to the target second data in the padding operation are stored in the second memory space as the third data.

At this point, two segments of second data, with sizes of 4064 B and 32 B respectively, are stored in the first memory space; and three segments of third data, with sizes of 32 B, 32 B and 4032 B respectively, are stored in the second memory space, where the first segment 32 B is the cyclic redundancy check information of the second data of 4064 B, the second segment 32 B is the cyclic redundancy check information of the padded data composed of the second data of 32 B and the padding data of 4032 B, and 4032 B is the padding data added to the second data of 32 B in the padding operation.

Then, the data management module determines position information of the multiple segments of second data in the first data; determines the data assembly order based on the position information and an association relationship between the second data and the third data; and generates a data assembly instruction based on a data assembly order for the second data and the third data, wherein the data assembly instruction is used for generating fourth data with a target data structure, the target data structure indicates data sources of each segment of subdata in the fourth data, and the subdata includes the second data and the third data.

In this example, the target data structure includes five segments of subdata. Specifically, the first segment of subdata is the cyclic redundancy check information of the second data of 4064 B, corresponding to a memory address of addr1 and a length of 32 B; the second segment of subdata is the second data, corresponding to a memory address of addr0 and a length of 4064 B; the third segment of subdata is the cyclic redundancy check information of the padded data composed of the second data of 32 B and the padding data of 4032 B, corresponding to a memory address extended by 32 B from addr1 and a length of 32 B; the fourth segment of subdata is the second data, corresponding to a memory address extended by 4064 B from addr0 and a length of 32 B; and the fifth segment of subdata is the padding data, corresponding to a memory address extended by 64 B from addr1 and a length of 4032 B.

Based on the foregoing, the data management module 120 is configured to send the data assembly instruction to the storage acceleration module 130, and accordingly, the storage acceleration module 130, after receiving the data assembly instruction, is configured to control the hard disk to read the second data and the third data from the target memory space, and write the fourth data into the hard disk based on the read data and the target data structure.

Specifically, the storage acceleration module 130 is configured to control the hard disk to read the second data from the first memory space of the target memory space and the third data from the second memory space of the target memory space based on the data sources of each segment of subdata in the fourth data indicated by the data assembly instruction, and combine the read second data and third data according to the target data structure based on the read data and the target data structure indicated by the data assembly instruction, so as to write the fourth data into the hard disk.

In order to enable data received by the network card module 110 to be submitted to the hard disk 140, and to achieve copy-free data transmission between the network card module 110, the data management module 120 and the storage acceleration module 130, the network card module 110 and the storage acceleration module 130 can register each other's memory, thus ensuring that the memory of the RPC network library 112 in the network card module 110 can be accessed by the hard disk 140 and the memory of the storage acceleration module 130 can be accessed by the network card 111 in the network card module 110.

Specifically, the network card module 110 and the storage acceleration module 130 registering each other's memory may be realized as follows: the RPC network library 112 is configured to determine a memory mapping table of the network card module 110, the memory mapping table contains a mapping relationship between a virtual memory address and a physical memory address of the network card module 110, and the RPC network library 112 is configured to register the memory mapping table to the storage acceleration module 130 during initialization.

Similarly, the storage acceleration module 130 is also configured to determine a memory mapping table of the storage acceleration module 130, the memory mapping table contains a mapping relationship between a virtual memory address and a physical memory address of the storage acceleration module 130, and the storage acceleration module 130 is configured to register the memory mapping table to the RPC network library 112 during initialization.

In this way, the RPC network library 112 and the storage acceleration module 130 can access each other's memory, ensuring that the memory of the RPC network library 112 in the network card module 110 can be accessed by the hard disk 140 and the memory of the storage acceleration module 130 can be accessed by the network card 111 in the network card module 110.

Accordingly, in actual implementation, the storage acceleration module 130, when controlling the hard disk to read the second data and the third data from the target memory space, is configured to: acquire a memory mapping table of the network card module 110, wherein the memory mapping table contains a mapping relationship between a virtual memory address and a physical memory address of the network card module; control the hard disk 140 to determine physical memory addresses of the second data and the third data based on the memory mapping table; and control the hard disk 140 to read the second data and the third data based on the physical memory addresses.

In the above steps, after receiving the data assembly instruction sent by the data management module 120, the storage acceleration module 130 may be configured to control the hard disk 140 to determine the virtual memory addresses of the second data and the third data based on the data assembly instruction, and then to control the hard disk 140 to determine the physical memory addresses of the second data and the third data based on the mapping relationship between the virtual memory address and the physical memory address of the network card module indicated by the memory mapping table, so as to control the hard disk 140 to read the second data and the third data based on the physical memory addresses.

In this way, through the memory mapping table which records the mapping relationship between the virtual memory address and the physical memory address of the network card module, the hard disk may be controlled by the storage acceleration module to determine the physical memory addresses of the second data and the third data according to the memory mapping table, so that the hard disk is controlled to read the second data and the third data based on the physical memory addresses, and the direct access of the hard disk to the data transmitted by the network card module is realized. Therefore, the data may be directly transmitted between the network card module and the hard disk to avoid additional memory copying and data replication, thus contributing to the realization of efficient memory universality and zero-copy data transmission.

In concrete implementation, the storage acceleration module 130 is configured to use an SPDK to control the hard disk 140 to read the second data and the third data from the target memory space, and write the fourth data into the hard disk 140 based on the read data and the target data structure.

In this way, the storage acceleration module may control the data reading and data writing of the hard disk by using the SPDK, which runs in the user mode, thus eliminating the data copying process from a kernel buffer designed in a traditional IO path to a user buffer, so as to realize the data transfer from the user-mode memory to the hard disk without additional memory copying.

With continued reference to FIG. 2, it can be seen that the storage acceleration module is configured to control the hard disk to read the second data and the third data from the physical memory addresses corresponding to the virtual memory addresses of the second data and the third data, combine the read data according to the target data structure to obtain the fourth data of 8 KB, and write the fourth data of 8 KB into the hard disk. In this example, the fourth data include five subdata. The first subdata are the cyclic redundancy check information of the second data of 4064 B, with a length of 32 B; the second subdata are the second data, with a length of 4064 B; the third subdata are the cyclic redundancy check information of the padded data composed of the second data of 32 B and the padding data of 4032 B, with a length of 32 B; the fourth subdata are the second data, with a length of 32 B; and the fifth subdata are the padding data, with a length of 4032 B.

According to the data processing system provided by the embodiment of the present disclosure, a network card module, a data management module and a storage acceleration module all have read-write access permission for a first memory space, so that first data received by the network card module are shared among the modules without data transmission and copying, thus reducing resource occupation. In addition, by storing check information in a second memory space, using the storage acceleration module to control a hard disk to directly obtain data from the first memory space and the second memory space and directly write the data into the hard disk, and allowing the hard disk to assemble the data, zero-copy data transmission is achieved, and data assembly in the data management module is avoided, thus further reducing resource consumption.

Further, through the realization of memory universality and zero-copy data transmission, the delay of data transmission is effectively reduced, the bandwidth utilization rate of data transmission is improved, the memory occupation demand of the system is reduced, performance issues caused by memory bandwidth bottleneck and load occupancy are reduced, and the performance, efficiency, response speed and resource utilization rate of the system are improved.

The embodiment of the present disclosure describes the process of writing the data received by the network card module into the hard disk. As can be seen from FIG. 1, the data may be transmitted bidirectionally among the modules, so the data may also be read from the hard disk and written into the network card module.

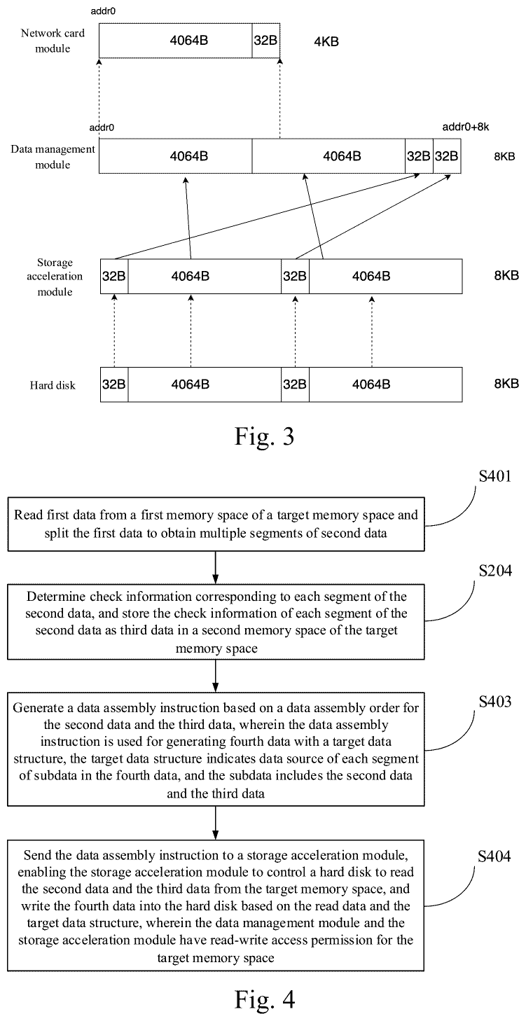

Accordingly, in order to clearly show the process of reading data from the hard disk and submitting the data to the network card module, FIG. 3 shows a schematic diagram of another data processing process according to an embodiment of the present disclosure. As shown in FIG. 3, 8 KB of fifth data are stored in the hard disk. In this example, the fifth data include four segments of subdata. The length of the first segment of subdata is 32 B, the length of the second segment of subdata is 4064 B, the length of the third segment of subdata is 32 B, and the length of the fourth segment of subdata is 4064 B. The data management module is configured to apply for a third memory space in the target memory space, a starting address of the third memory space is addr0, and an ending address is extended by 8 KB from addr0.

Then, the data management module is configured to send a data storage instruction to the storage acceleration module. The data storage instruction is used for storing sixth data with a target data structure, the target data structure indicates data sources of each segment of subdata in the sixth data, and the subdata in the sixth data are the subdata in the fifth data.

The storage acceleration module is configured to control the hard disk to recombine the subdata in the fifth data into the sixth data and store the same in the third memory space according to the data storage instruction. The data management module is configured to read the sixth data from the third memory space, and split the sixth data according to the target data structure to obtain multiple segments of seventh data. The first segment of seventh data corresponds to a memory address extended by 8128 B from addr0, and a length of 32 B. The second segment of seventh data corresponds to a memory address of addr0, and a length of 4064 B. The third segment of seventh data corresponds to a memory address extended by 8160 B from addr0, and a length of 32 B. The fourth segment of seventh data corresponds to a memory address extended by 4064 B from addr0, and a length of 4064 B.

Then, the data management module is configured to calculate and verify cyclic redundancy check information of each segment of the seventh data, to determine transmission data included in each segment of the seventh data and check information corresponding to the transmission data, and then to determine eighth data to be transmitted to the network card module based on the transmission data and the check information corresponding to the transmission data. The eighth data correspond to a memory address of addr0 and a length of 4 KB. The network card module is configured to read the eighth data from the third space.

In this way, through the data transmission from the storage acceleration module to the data management module to the network card module and the cooperation among the modules, the data may be read from the hard disk under the control of the storage acceleration module, and then written into the network card module through the calculation and verification of the data management module, thus avoiding additional memory copying and data replication, eliminating the data copying introduced by data reorganization in the related art, and realizing efficient memory universality and zero-copy data transmission.

It should be noted that the description of the processing flow of each component in the data processing system and the interaction flow between different components does not imply strict processing and interaction flows and does not impose any constraints on the implementation process, and the processing flow and interaction flow of each component should be determined by its function and possible internal logic.

Based on the same technical concept, an embodiment of the present disclosure also provides a data processing method corresponding to the data management module. Since the principle of solving problems by the data processing method in the embodiment of the present disclosure is similar to the above-mentioned data management module, the implementation of the data management module can be used as a reference for the implementation of the data processing method, which will not be repeated here.

Referring to FIG. 4 which is a flowchart of a data processing method according to an embodiment of the present disclosure, the data processing method is applied to a data management module. As shown in FIG. 4, the data processing method includes steps S401-S404.

In S401, reading first data from a first memory space of a target memory space and splitting the first data to obtain multiple segments of second data.

In S402, determining check information corresponding to each segment of the second data, and storing the check information of each segment of the second data as third data in a second memory space of the target memory space.

In S403, generating a data assembly instruction based on a data assembly order for the second data and the third data, wherein the data assembly instruction is used for generating fourth data with a target data structure, the target data structure indicates data source of each segment of subdata in the fourth data, and the subdata includes the second data and the third data.

In S404, sending the data assembly instruction to a storage acceleration module, enabling the storage acceleration module to control a hard disk to read the second data and the third data from the target memory space, and write the fourth data into the hard disk based on the read data and the target data structure. Here, the data management module and the storage acceleration module have read-write access permission for the target memory space.

The data processing method provided by the embodiment of the present disclosure involves splitting the first data stored in the first memory space to obtain the multiple segments of second data, determining the check information of each segment of second data and storing the same as the third data in the second memory space, determining the data assembly instruction for generating the fourth data with the target data structure, and sending the data assembly instruction to the storage acceleration module, so that the storage acceleration module controls the hard disk to read the second data and the third data from the target memory space, enabling the writing of the fourth data into the hard disk in compliance with the target data structure, including the second data and the third data. In this way, through the data transmission from the data management module to the storage acceleration module and the cooperation between the modules, the data are split by the data management module after being received from the network card module, and then written into the hard disk under the control of the storage acceleration module, thus avoiding additional memory copying and data replication, eliminating the data copying introduced by data reorganization in the related art, and realizing efficient memory universality and zero-copy data transmission.

Further, through the realization of memory universality and zero-copy data transmission, the delay of data transmission is effectively reduced, the bandwidth utilization rate of data transmission is improved, the memory occupation demand of the system is reduced, performance issues caused by memory bandwidth bottleneck and load occupancy are reduced, and the performance, efficiency, response speed and resource utilization rate of the system are improved.

The embodiment of the present disclosure describes the process of writing the data received by the network card module into the hard disk. Accordingly, in other embodiments, another data processing method is provided to realize the process of reading data from the hard disk and submitting the same to the network card module. Here, the implementation of the data management module can be used as a reference for the specific implementation of the data processing method, which will not be repeated here.

It can be understood by those skilled in the art that in the above-mentioned method according to specific implementations, the order of writing the steps does not necessarily imply a strict execution sequence or impose any limitations on the implementation process. The specific execution sequence of each step should be determined based on its functionality and possible inherent logic.

Based on the same technical concept, an embodiment of the present disclosure also provides a data processing apparatus corresponding to the data processing method. Since the principle of solving problems by the data processing apparatus in the embodiment of the present disclosure is similar to the above-mentioned data processing method, the implementation of the data processing method can be used as a reference for the implementation of the data processing apparatus, which will not be repeated here.

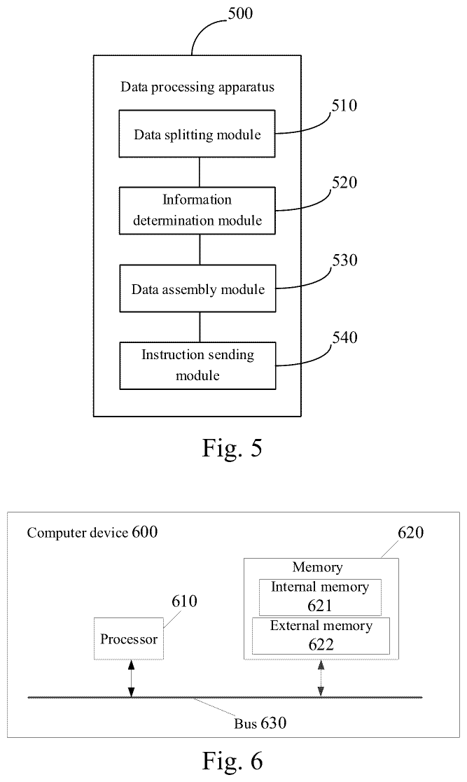

Referring to FIG. 5 which is a schematic diagram of a data processing apparatus according to an embodiment of the present disclosure, the data processing apparatus is applied to the above-mentioned data management module. The data processing apparatus may be the same device as the data management module with different names, and the data processing apparatus may also be a part of the data management module. Modules in the data processing apparatus and units with corresponding functions in the data management module may be coupled together to jointly realize the same function. As shown in FIG. 5, the data processing apparatus 500 provided by the embodiment of the present disclosure includes:

In a third aspect, the embodiment of the present disclosure also provides a data processing device, which includes a data splitting module 510, an information determination module 520, a data assembly module 530 and an instruction sending module 540,
a data splitting module 510 is configured to read first data from a first memory space of a target memory space and split the first data to obtain multiple segments of second data;
an information determination module 520 is configured to determine check information corresponding to each segment of the second data, and store the check information of each segment of the second data as third data in a second memory space of the target memory space;
a data assembly module 530 is configured to generate a data assembly instruction based on a data assembly order for the second data and the third data, wherein the data assembly instruction is used for generating fourth data with a target data structure, the target data structure indicates data sources of each segment of subdata in the fourth data, and the subdata includes the second data and the third data; and
an instruction sending module 540 is configured to send the data assembly instruction to a storage acceleration module, enabling the storage acceleration module to control a hard disk to read the second data and the third data from the target memory space, and write the fourth data into the hard disk based on the read data and the target data structure; wherein the data management module and the storage acceleration module have read-write access permission for the target memory space.

The data processing apparatus provided by the embodiment of the present disclosure involves splitting the first data stored in the first memory space to obtain the multiple segments of second data, determining the check information of each segment of second data and storing the same as the third data in the second memory space, determining the data assembly instruction for generating the fourth data with the target data structure, and sending the data assembly instruction to the storage acceleration module, so that the storage acceleration module controls the hard disk to read the second data and the third data from the target memory space, enabling the writing of the fourth data into the hard disk in compliance with the target data structure, including the second data and the third data. In this way, through the data transmission from the data management module to the storage acceleration module and the cooperation between the modules, the data are split by the data management module after being received from the network card module, and then written into the hard disk under the control of the storage acceleration module, thus avoiding additional memory copying and data replication, eliminating the data copying introduced by data reorganization in the related art, and realizing efficient memory universality and zero-copy data transmission.

Further, through the realization of memory universality and zero-copy data transmission, the delay of data transmission is effectively reduced, the bandwidth utilization rate of data transmission is improved, the memory occupation demand of the system is reduced, performance issues caused by memory bandwidth bottleneck and load occupancy are reduced, and the performance, efficiency, response speed and resource utilization rate of the system are improved.

For the process flow of each module in the apparatus and the interactive process between modules, please refer to the relevant description in the above method embodiment, which will not be repeated here.

Corresponding to the above data processing method, an embodiment of the present disclosure further provides a computer device. Referring to FIG. 6 which is a schematic diagram of a computer device according to an embodiment of the present disclosure, the computer device includes:
a processor 610, a memory 620, and a bus 630. The memory 620 is configured to store execution instructions, and includes an internal memory 621 and an external memory 622. Here, the internal memory 621, also called internal storage, is configured to temporarily store operation data in the processor 610 and data exchanged with the external memory 622 such as a hard disk. The processor 610 exchanges data with the external memory 622 through the internal memory 621.

In the embodiment of the present application, the memory 620 is specifically configured to store an application code for executing the scheme of the present application, and the execution is controlled by the processor 610. That is, when the computer device 600 is running, the processor 610 communicates with the memory 620 through the bus 630, so that the processor 610 executes the application code stored in the memory 620, so as to execute the steps of the data processing method described in any of the foregoing embodiments.

The memory 620 may be, but is not limited to, a random access memory (RAM), a read only memory (ROM), a programmable read-only memory (PROM), an erasable programmable read-only memory (EPROM), an electric erasable programmable read-only memory (EEPROM), etc.

The processor 610 may be an integrated circuit chip with signal processing capability. The processor may be a general processor, including a central processing unit (CPU) and a network processor (NP), and may also be a digital signal processor (DSP), an application specific integrated circuit (ASIC), a field programmable gate array (FPGA) or other programmable logic devices, discrete gate or transistor logic devices, and discrete hardware components, which can realize or execute the method, steps and logic block diagrams disclosed in the embodiments of the present disclosure. The general processor may be a microprocessor or the processor may be any conventional processor.

It can be understood that the schematic structure of the embodiment of the present application does not constitute a specific limitation to the computer device 600. In other embodiments of the present application, the computer device 600 may include more or fewer components than shown, or combine some components, or split some components, or have different component arrangements. The illustrated components may be implemented in hardware, software or a combination of software and hardware.

For the specific execution process of the above instructions, the steps of the data processing method described in the embodiment of the present disclosure may be used for reference, which will not be repeated here.

An embodiment of the present disclosure also provides a computer-readable storage medium, on which a computer program is stored, and when the computer program is run by a processor, the steps of the data processing method described in the above method embodiments are executed. The storage medium can be a volatile or nonvolatile computer-readable storage medium.

An embodiment of the present disclosure also provides a computer program product, which carries a program code, and the program code includes instructions that can be used to execute the steps of the data processing method described in the above method embodiments. For details, please refer to the above-mentioned method embodiment, which is not repeated here.

The above computer program product can be implemented through hardware, software, or their combination. In one alternative embodiment, the computer program product is embodied as a computer storage medium, and in another alternative embodiment, the computer program product is embodied as a software product, such as a Software Development Kit (SDK).

It can be clearly understood by those skilled in the art that for the convenience and conciseness of description, to understand the specific working process of the system and apparatus described above, one can refer to the corresponding process in the aforementioned method embodiment, which will not be repeated here. In several embodiments provided by this disclosure, it should be understood that the disclosed system, apparatus and method can be realized in other ways. The apparatus embodiment described above is only schematic. For example, the division of the units is only a logical function division, and there may be other division methods in actual implementation. For another example, multiple units or components may be combined or integrated into another system, or some features may be ignored or not implemented. Furthermore, the displayed or discussed coupling or direct coupling or communication can be indirect coupling or communication through some communication interfaces, apparatuses, or units, which can be electrical, mechanical, or in other forms.

The units described as separate components may or may not be physically separated, and the components displayed as units may or may not be physical units, i.e., may be located in one place or may be distributed over plurality of network units. Some or all of the units can be selected according to actual needs to achieve the purpose of this embodiment.

In addition, all functional units in each embodiment of the present disclosure may be integrated into one processing unit, or exist physically separated, or two or more units may be integrated into one unit.

If the functions are realized in the form of software functional units and sold or used as independent products, they can be stored in a processor-executable nonvolatile computer-readable storage medium. Based on this understanding, the essence of the technical scheme of the present disclosure, or the part that contributes to the prior art, or part of this technical scheme, can be embodied in the form of a software product, which is stored in a storage medium and includes several instructions to make a computer device (which can be a personal computer, a server, a network device, etc.) execute all or part of the steps of the method described in various embodiments of the present disclosure. The aforementioned storage media include: USB flash disk, mobile hard disk, read-only memory (ROM), random access memory (RAM), magnetic disk or optical disk and other media that can store program codes.

Finally, it should be noted that the above-mentioned embodiments are only specific implementations of the present disclosure, which are used to illustrate the technical scheme of the present disclosure, but not to limit it. The protection scope of the present disclosure is not limited to these embodiments. Although the present disclosure has been described in detail with reference to the above-mentioned embodiments, it should be understood by those of ordinary skill in the art that any technician familiar with the technical field can still modify or easily think of changes to the technical scheme recorded in the above-mentioned embodiments within the technical scope of the present disclosure, or equivalently replace certain technical features described in the aforementioned embodiments. These modifications, changes or substitutions do not make the essence of the corresponding technical scheme deviate from the spirit and scope of the technical scheme of the embodiments of this disclosure, and should be included in the protection scope of this disclosure. Therefore, the scope of protection of this disclosure should be based on the scope of protection of the claims.

What is claimed is:

1. A data processing system, comprising a network card module, a data management module, a storage acceleration module and a hard disk; wherein the network card module, the data management module and the storage acceleration module have read-write access permission for a target memory space;
the network card module is configured to receive first data transmitted by a network and store the first data in a first memory space of the target memory space;
the data management module is configured to read the first data from the first memory space and split the first data to obtain multiple segments of second data; determine check information corresponding to each segment of the second data, and store the check information of each segment of the second data as third data in a second memory space of the target memory space; and generate a data assembly instruction based on a data assembly order for the second data and the third data; wherein the data assembly instruction is used for generating fourth data with a target data structure, the target data structure indicates data source of each segment of subdata in the fourth data, and the subdata comprises the second data and the third data; and
the storage acceleration module is configured to control the hard disk to read the second data and the third data from the target memory space, and write the fourth data into the hard disk based on read data and the target data structure.

2. The system according to claim 1, wherein the network card module, the data management module and the storage acceleration module run in a same thread.

3. The system according to claim 1, wherein the storage acceleration module, when controlling the hard disk to read the second data and the third data from the target memory space, is configured to:
acquire a memory mapping table of the network card module, wherein the memory mapping table contains a mapping relationship between a virtual memory address and a physical memory address of the network card module;
control the hard disk to determine physical memory addresses of the second data and the third data based on the memory mapping table; and
control the hard disk to read the second data and the third data based on the physical memory addresses.

4. The system according to claim 1, wherein the storage acceleration module, when controlling the hard disk to read the second data and the third data from the target memory space, and write the fourth data into the hard disk based on the read data and the target data structure, is configured to:
use a storage performance development kit (SPDK) to control the hard disk to read the second data and the third data from the target memory space, and write the fourth data into the hard disk based on the read data and the target data structure.

5. The system according to claim 1, wherein the data management module determines the data assembly order by following steps:
determining position information of the multiple segments of second data in the first data; and
determining the data assembly order based on the position information and an association relationship between the second data and the third data.

6. The system according to claim 1, wherein the data management module is configured to:
split the first data based on a preset data segmentation size to obtain multiple segments of second data, and perform a padding operation on target second data at a tail end of the first data to obtain padded data;
determine cyclic redundancy check information corresponding to other second data than the target second data and cyclic redundancy check information of the padded data;
for any of the other second data, take the cyclic redundancy check information of the other second data as check information corresponding to the other second data;
take the cyclic redundancy check information of the padded data as check information of the target second data; and
store padding data added to the target second data in the padding operation into the second memory space as the third data.

7. A data processing method applied to a data management module, comprising:
reading first data from a first memory space of a target memory space and splitting the first data to obtain multiple segments of second data;
determining check information corresponding to each segment of the second data, and storing the check information of each segment of the second data as third data in a second memory space of the target memory space;
generating a data assembly instruction based on a data assembly order for the second data and the third data, wherein the data assembly instruction is used for generating fourth data with a target data structure, the target data structure indicates data source of each segment of subdata in the fourth data, and the subdata comprises the second data and the third data; and
sending the data assembly instruction to a storage acceleration module, enabling the storage acceleration module to control a hard disk to read the second data and the third data from the target memory space, and write the fourth data into the hard disk based on the read data and the target data structure; wherein the data management module and the storage acceleration module have read-write access permission for the target memory space.

8. A computer device, comprising at least one processor and at least one memory, wherein the at least one memory stores machine-readable instructions executable by the at least one processor, the at least one processor is used for executing the machine-readable instructions stored in the at least one memory, and when the machine-readable instructions are executed by the at least one processor, the at least one processor executes a data processing method, the method comprises:
reading first data from a first memory space of a target memory space and splitting the first data to obtain multiple segments of second data;
determining check information corresponding to each segment of the second data, and storing the check information of each segment of the second data as third data in a second memory space of the target memory space;
generating a data assembly instruction based on a data assembly order for the second data and the third data, wherein the data assembly instruction is used for generating fourth data with a target data structure, the target data structure indicates data source of each segment of subdata in the fourth data, and the subdata comprises the second data and the third data; and
sending the data assembly instruction to a storage acceleration module, enabling the storage acceleration module to control a hard disk to read the second data and the third data from the target memory space, and write the fourth data into the hard disk based on the read data and the target data structure; wherein the data management module and the storage acceleration module have read-write access permission for the target memory space.

9. A non-transitory computer-readable storage medium, wherein a computer program is stored on the non-transitory computer-readable storage medium, and when the computer program is run on a computer device, the computer device executes the steps of the data processing method according to claim 7.
